(19) United States
(12) Patent Application Publication
(10) Pub. No.: US 2016/0053720 A1
(43) Pub. Date: Feb. 25, 2016

(54) MECHANICAL INHIBITING DEVICE INTEGRATED INTO A DEFENCE LINE OF A THRUST REVERSER

(71) Applicant: AIRCELLE, GONFREVILLE L'ORCHER (FR)

(72) Inventors: Hazem KIOUA, SAINT JOUIN BRUNEVAL (FR); Laurent Georges VALLEROY, LE HAVRE (FR); Jerome LESCURE, ROUEN (FR); Jerome CORFA, CRESSEVEUILLE (FR)

(73) Assignee: AIRCELLE, GONFREVILLE L'ORCHER (FR)

(21) Appl. No.: 14/852,462

(22) Filed: Sep. 11, 2015

Related U.S. Application Data
(63) Continuation of application No. PCT/FR2014/050577, filed on Mar. 13, 2014.

(30) Foreign Application Priority Data
Mar. 15, 2013 (FR) FR 13/52329

(51) Int. Cl. F02K 1/76; F02K 1/72

(52) U.S. Cl. CPC F02K 1/766; F02K 1/72; F05D 2240/90

(57) ABSTRACT

The present disclosure provides a thrust reverser device for a nacelle of a by-pass turbojet engine, including: a cowl moving alternately between a deployed position in which the cowl opens a passage within the nacelle and a retracted position in which the cowl closes the passage; a locking/unlocking system to lock and unlock the cowl, the locking/unlocking system moving alternately between a closed position in which a bolt cooperates with a striker so as to hold the cowl in the retracted position, and an open position in which the bolt releases the striker, so as to allow a switching of the cowl from the retracted position to the deployed position; and a device for mechanically inhibiting the cowl from a movement, holding in the retracted position. In particular, the mechanical inhibition device holds the locking/unlocking system in the closed position.

### CROSS-REFERENCE TO RELATED APPLICATIONS

This application is a continuation of International Application No. PCT/FR2014/050577, filed on Mar. 13, 2014, which claims the benefit of FR 13/52329, filed on Mar. 15, 2013. The disclosures of the above applications are incorporated herein by reference.

### FIELD

The present disclosure relates to a thrust reverser device for a nacelle of a bypass turbojet engine, as well as to a nacelle equipped with such a device.

### BACKGROUND

The statements in this section merely provide background information related to the present disclosure and may not constitute prior art.

An aircraft is driven by several turbojet engines each housed in a nacelle.

A nacelle generally presents a tubular structure comprising an air inlet upstream of the turbojet engine, a mid-section intended to surround a fan of the turbojet engine, a downstream section integrating thrust reversal means and intended to surround the combustion chamber of the turbojet engine, and is generally terminated by an ejection nozzle the outlet of which is located downstream of the turbojet engine.

Modern nacelles are intended to accommodate a bypass turbojet engine capable of generating, on the one hand, a hot air flow (also called primary flow) coming from the combustion chamber of the turbojet engine, and on the other hand, a cold air flow (secondary flow) coming from the fan and circulating outside the turbojet engine through an annular passage, also called duct, formed between an internal structure defining a fairing of the turbojet engine and an inner wall of the nacelle. Both air flows are ejected from the turbojet engine through the rear of the nacelle.

The role of a thrust reverser, during landing of an aircraft, is to improve the breaking ability of the latter by redirecting forward at least a part of the thrust generated by the turbojet engine. In this phase, the thrust reverser obstructs the duct of cold flow and directs the latter to the front of the nacelle, thereby generating a counter-thrust which adds to the breaking of the wheels of the aircraft.

The means implemented to achieve this cold flow redirection vary depending on the thrust reverser type. However, in all cases, the structure of a thrust reverser comprises movable cowls displaceable between, on the one hand, a deployed position in which they open within the nacelle a passage intended for the diverted flow, and on the other hand, a retracted position in which they close this passage. These cowls may fulfill a function of deflection or simply actuation of other diverting means.

In the case of a cascade-type thrust reverser, also known under the name of cascade-type thrust reverser, the redirection of the air flow is achieved by cascade vanes, the cowl having only one simple sliding function aiming to uncover or cover these cascades. Complementary blocking doors, also called flaps, which are actuated by sliding of the cowling, generally enable a closing of the duct downstream of the cascades so as to optimize the redirection of the cold flow.

Referring to FIG. 1, which illustrates a cascade-type thrust reverser 1 well known in the prior art.

It includes a fixed structure constituted by a front frame 3 and a rear frame 5, the front frame 3 and the rear frame 5 being connected together by longitudinal beams 7 substantially parallel to a longitudinal axis 9 of the thrust reverser device.

The longitudinal beams 7 are diametrically opposite to each other with respect to the longitudinal axis 9, the first longitudinal beam 7a, called “12 o-clock” beam, facing the mast of the aircraft, namely usually at the top of the thrust reverser, the second longitudinal beam 7b, called “6 o-clock” beam, being diametrically opposite to the first beam with respect to the longitudinal axis 9, namely usually at the bottom of the thrust reverser.

The thrust reverser 1 also includes at least one movable element typically constituted by two cowls 11 which are movable between a retracted position covering the cascade vanes 13 of a secondary air flow and a deployed position (as is represented in FIG. 1) according to which said cowls are in a position downstream of the nacelle, uncovering the cascade vanes, so as to enable redirection of the air flow passing through the nacelle toward the upstream of the nacelle during a reverse jet operation.

The upstream and the downstream of the nacelle are defined with reference to the flowing direction of the air flow in the nacelle in direct jet operation, the upstream of the nacelle corresponding to a portion of the nacelle through which the flow penetrates, and the downstream corresponding to an ejection area of said air flow.

Note that in the case of an O-duct type thrust reverser (<<O>>-shaped channel), the fixed structure of the thrust reverser comprises a front frame and a rear frame connected to each other by one single top-set longitudinal beam at 12 o'clock, and the movable structure of the thrust reverser comprises one single cowl, movable between its retracted position and its deployed position.

The thrust reverser further comprises means for guiding the cowls, comprising a rail secured to each cowl and sliding in slides which are attached to the longitudinal beams, for examples on their sidewalls.

Conventionally, the switching from a retracted position to a deployed position is carried out by means of control means usually constituted by screw jacks 15 attached to the front frame 3 and parallel to the slides.

Referring to FIG. 2, which represents the cascade-type thrust reverser device 1 (the right-side portion of the thrust reverser having been removed for better visibility).

Such a device is equipped with internal safeties generally comprising two locking/unlocking systems called primary locks (PLS: Primary Lock System), and a locking/unlocking system 17 called tertiary lock (TLS: Tertiary Lock System), generally positioned at the lower portion of the movable cowl 11 of the thrust reverser.

For an <<O-duct>>-type thrust reverser, the locking/unlocking system of the thrust reverser is typically disposed at the rear end of the slide in which the guide rail, secured to the sliding cowl, moves.

Referring now to FIG. 3, which illustrates a door-type thrust reverser device 19 well known in the prior art.

Redirection of the air flow is carried out by switching the doors 21 from a retracted position (as is represented in the figure) to a deployed position according to which the doors open toward the outside of the thrust reverser device.

FIG. 4 illustrates one form of the locking/unlocking system 23 equipped with the door-type thrust reverser devices 19 according to the prior art.

Typically, a door comprises two locking/unlocking systems, positioned upstream of the door, on either side of a longitudinal plane P that passes by the longitudinal axis 9 of the thrust reverser device (see FIG. 3).

The locking/unlocking system 23 comprises an S-shaped bolt 25 capable of cooperating with two strikers 27 and 29 each secured to a door (not represented).

The bolt 25 is in turn secured to a fixed structure 31 of the thrust reverser device 1, and is pivotally mounted on a substantially radial axis 33.

In the closed position of the locking/unlocking system, the bolt 25 cooperates with the strikers 27 and 29 thereby holding the doors in a retracted position. The switching of the locking/unlocking system in an open position is carried out by pivoting the bolt 25 thereby causing the release of the strikers 27 and 29 and authorizing the switching of the doors in the deployed position.

Regardless of the thrust reverser type, whether it is of the cascade-type or of the door-type, the locking systems move alternately between a closed position where at least one bolt cooperates with at least one striker so as to provide holding of the movable element in its retracted position, and an open position where said bolt releases said striker, so as to authorize the switching of said movable element in its deployed position.

These locks avoid an inadvertent deployment of a movable element of the thrust reverser in flight, which could be catastrophic.

When one of the internal safeties of the thrust reverser is damaged, the nacelle is temporarily equipped with a device for mechanically inhibiting the movable element of the thrust reverser. This device allows holding the movable element of the thrust reverser device for which the locking/unlocking system is damaged in its retracted position.

Typically, this device is installed on the ground subsequently to a malfunction signal of one of the locking/unlocking devices detected by means of sensors and informing the pilot of the breakdown.

By installing this device for mechanically inhibiting the thrust reverser device, the aircraft remains authorized to fly, despite of the breakdown and in complete safety. The breakdown will be subsequently subjected to maintenance operations.

In other words, the locking/unlocking system is a system that can be actuated from the cockpit of the aircraft, unlike the mechanical inhibition device which is a device that is manually installed when the aircraft is on the ground. The locking/unlocking device prevents the deployment of the thrust reverser when the aircraft is in flight, and authorizes its deployment when the aircraft is on the ground, in order to enhance the breaking ability of the aircraft during landing. In turn, the mechanical inhibition device allows inhibiting the operation of the thrust reverser throughout the operation of the aircraft, that is to say, preventing its deployment when the aircraft is in flight but also when the aircraft is on the ground.

In the case of a cascade-type thrust reverser, such a mechanical inhibition is generally achieved by screwing the movable cowls to a fixed structure of the nacelle, and/or by setting up blocking pins 35 (visible in FIG. 2) downstream of the movable cowls along a substantially radial direction, said pins thereby acting as abutment means preventing any longitudinal translational motion of the movable cowl.

In the case of a door-type thrust reverser, such a mechanical inhibition is typically achieved by placing an inhibiting pin 37 between the door (not represented) and a door support frame 39, as is illustrated in FIG. 5.

In such a door-type reverser, the pins or screws have to be stored on the aircraft, generally inside a housing that is arranged in the nacelle. Then, the setting up of the pins or the screwing of the cowls is a time-consuming and tedious operation which requires adapted tools.

Furthermore, the time that is required for setting up the mechanical inhibition device is relatively long, and access to the areas of the nacelle that receive this mechanical inhibition device is generally quite inconvenient.

### SUMMARY

The present disclosure provides a thrust reverser device for a nacelle of a by-pass turbojet engine, comprising:
means for diverting at least one portion of an air flow of the turbojet engine, said diverting means comprising at least one movable element alternately between a deployed position according to which it opens a passage within the nacelle and a retracted position according to which it closes said passage,
a system for locking/unlocking said movable element, moving alternately between a closed position according to which at least one bolt cooperates with at least one striker so as to provide holding of said movable element in its retracted position, and an open position according to which said bolt releases said striker, so as to authorize the switching of said movable element from its retracted position to its deployed position,
a device for mechanically inhibiting said movable element, providing its holding in its retracted position,

said thrust reverser device being remarkable in that the mechanical inhibition device comprises means for holding the locking/unlocking system in its closed position.

Thus, by providing a mechanical inhibition device that acts directly on the locking/unlocking system of the movable element of the thrust reverser device, the setting up of the mechanical inhibition device is achieved in a simple manner by access to the locking/unlocking system, which simplifies its setting up and advantageously allows reducing assembly costs and maintenance time.

Indeed, unlike the prior art which provided for a mechanical inhibition device installed at the rear portion of each movable cowl of the thrust reverser device when the latter is of the <<cascade>>-type, or for an inhibiting pin mounted astride between each door and its support frame when the thrust reverser device is of the <<door>>-type, the mechanical inhibition device according to the present disclosure acts directly on the locking/unlocking system of a movable cowl or a door of the thrust reverser device

Thus, the mechanical inhibition device according to the present disclosure allows holding in the closed position the locking/unlocking system of one or more cowl(s) or door(s) of the thrust reverser device, and consequently holding in the retracted position said cowl(s) or said door(s) if a malfunction of an element of the nacelle has been detected.

Consequently, the setting up of the mechanical inhibition device, achieved by opening an access hatch to the locking/unlocking device of the movable element, is simplified in comparison with the prior art.

According to other features of the present disclosure, the locking/unlocking system comprises:
at least one bolt secured to a fixed structure of the thrust reverser device and pivotally mounted on a substantially radial pivot axis, and
at least one striker secured to said movable element and adapted so as to cooperate with said bolt at least for one closed position of said locking/unlocking system so as to provide holding of said movable element in the retracted position,
   and the means for holding the locking/unlocking system in its closed position comprise at least one inhibiting pin or at least one inhibiting screw positioned so as to block pivoting of said bolt from its closed position to its open position.

According to a first form of the thrust reverser device, the movable element is a door of a door-type thrust reverser device, and the fixed structure comprises at least one bore shaped so as to receive said inhibiting pin or said inhibiting screw.

In one form, the bolt further comprises a bore positioned facing said bore of the fixed structure of the thrust reverser device when the locking/unlocking system is in the closed position, and shaped so as to receive said inhibiting pin or said inhibiting screw.

Alternatively, the movable element includes a door of a door-type thrust reverser device, and the fixed structure comprises a bore positioned proximate to said bolt and shaped so as to receive said inhibiting screw so as to block pivoting of said bolt from its closed position toward its open position.

According to a second form of the thrust reverser device according to the present disclosure, the movable element is a cowl of a cascade-type thrust reverser device, said cowl being movable in translation by means of at least one guide rail sliding along a direction substantially parallel to a longitudinal axis of said thrust reverser device along at least one slide secured to a fixed structure of the thrust reverser, and the guide rail comprises means for supporting said inhibiting pin or said inhibiting screw positioned proximate to said bolt so as to block pivoting of said bolt from its closed position to its open position when the movable cowl is in its retracted position.

In another form, the fixed structure of the thrust reverser device comprises a 12 o'clock beam and at least one front frame, and the cowl is an O-duct type cowl.

According to another feature according to the present disclosure, the locking/unlocking system consists of a tertiary lock.

The present disclosure also concerns a nacelle for a bypass turbojet engine comprising:
a front section for air inlet,
a mid-section intended to surround a turbojet engine fan, and
a rear section equipped with a thrust reverser device according to the present disclosure.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIGS. 1 and 2 illustrate cascade-type thrust reversers according to the prior art;

FIG. 3 represents a door-type thrust reverser according to the prior art;

FIGS. 4 and 5 respectively illustrate a device for locking/unlocking the doors of a door-type thrust reverser according to the prior art, and a mechanical inhibition device for a door-type thrust reverser according to the prior art;

FIG. 6 illustrates the mechanical inhibition device for a door-type thrust reverser device according to the present disclosure;

FIG. 7 represents a variant of the mechanical inhibition device represented in FIG. 6; and

FIG. 8 is a representation of the mechanical inhibition device for a cascade-type thrust reverser device according to the present disclosure.

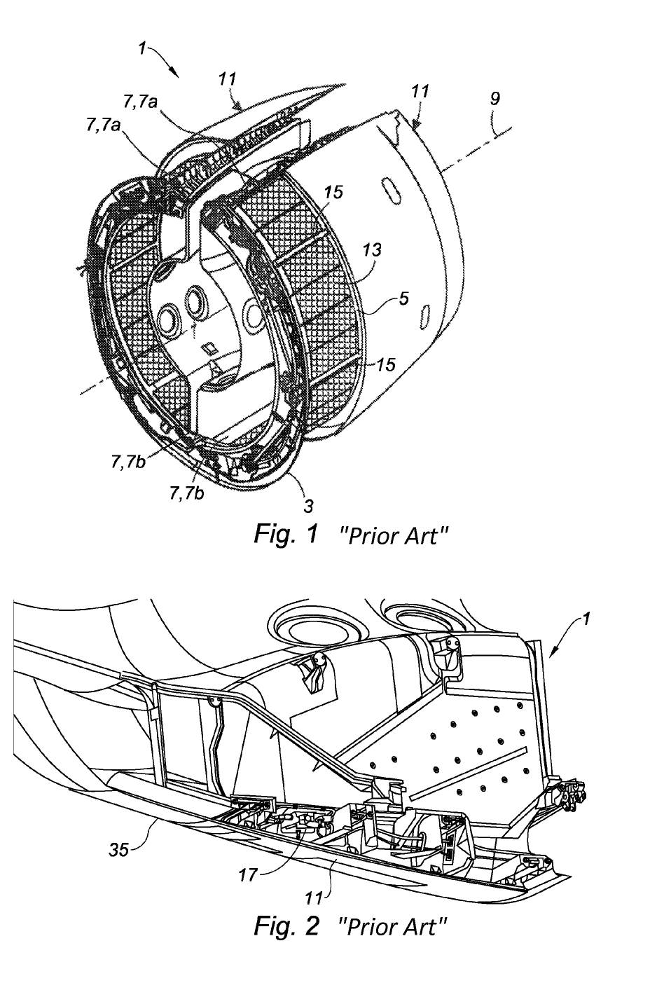

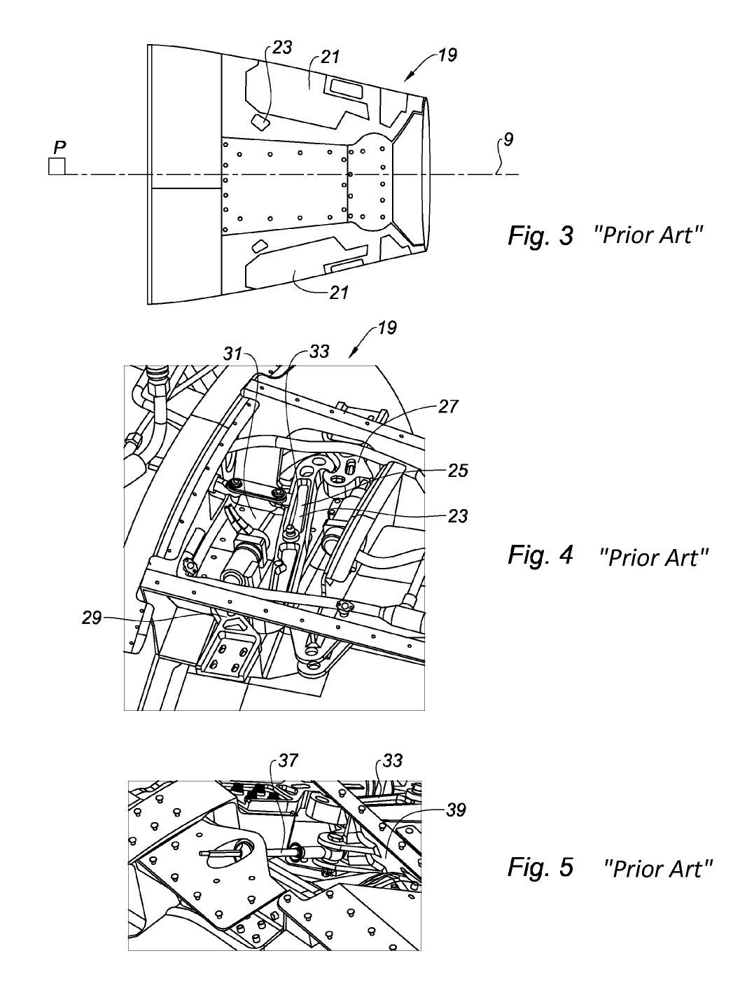

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

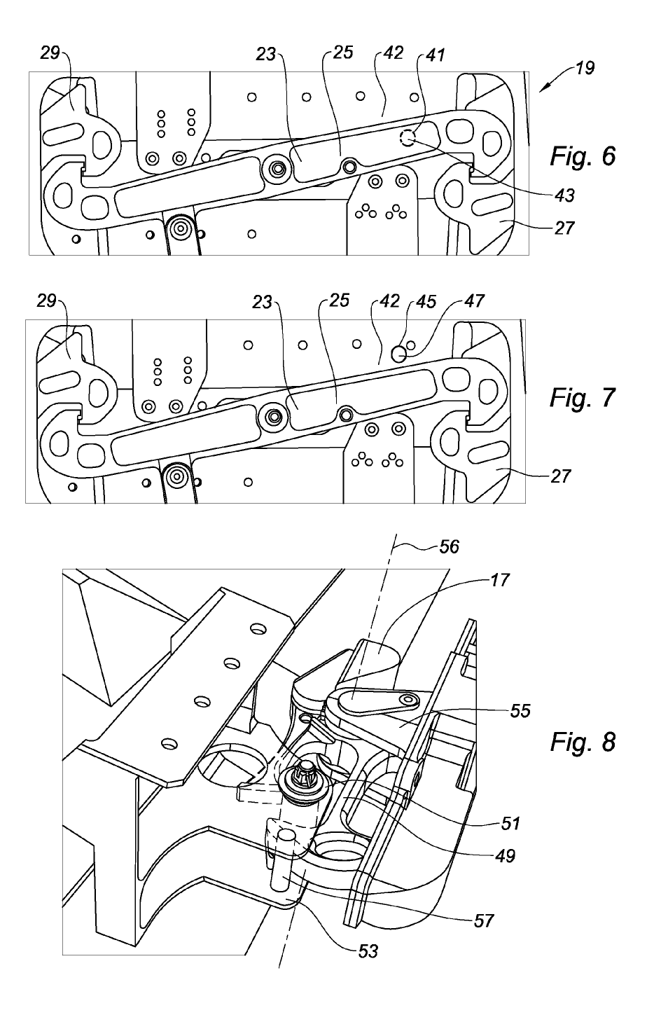

Referring to FIG. 6, a means for holding a locking/unlocking system in the closed position according to a first form of the thrust reverser device is illustrated according to the present disclosure.

The thrust reverser device (hereinafter called <<the thrust reverser>>) represented in this figure is of the <<door>>-type, that is to say the movable element of the thrust reverser is a door.

The locking/unlocking system 23 of the doors comprises, as previously described with reference to FIG. 4, a bolt 25 cooperating with the strikers 27 and 29 each secured to a door (not represented) when said locking/unlocking system is in a closed position.

According to this first form of the present disclosure, the bolt comprises a bore 41 positioned facing a bore supported by the fixed structure 42 of the thrust reverser.

The mechanical inhibition device comprises means for holding the bolt 25 of the locking/unlocking system 23 of the doors in its closed position, which means are constituted by an inhibiting pin 43 shaped so as to penetrate the bore 41 of the bolt 25 and the bore of the fixed structure 42 of the thrust reverser, when the bolt is in its closed position.

According to a non-represented variant, the bore 41 of the bolt and the bore of the fixed structure 42 of the thrust reverser may be threaded, and the means for holding the bolt 25 of the locking/unlocking system 23 in its closed position are then constituted by an inhibiting screw shaped so as to penetrate the bore 41 and the bore 42.

Thus, the inhibiting pin 43 or the inhibiting screw blocks the pivoting of the bolt, the latter being held in its closed position and providing the holding of the doors in the retracted position.

According to a variant represented in FIG. 7, only the structure of the thrust reverser comprises a bore 45 positioned proximate to the bolt 25.

The bore 45 of the fixed structure of the thrust reverser 42 is threaded and shaped so as to receive an inhibiting screw 47. By <<positioned proximate to the bolt>>, it is meant a positioning of the bore 45 in the surface that is swept by the pivoting of the bolt during the switching from its closed position to its open position, the positioning being such that the pivoting of the bolt 25 is blocked by the inhibiting screw 47 so as to hold the bolt 25 in its closed position.

Referring now to FIG. 8, a mechanical inhibition device is illustrated according to the present disclosure when the thrust reverser device is of the <<cascade>>-type.

The locking/unlocking system 17 of the cowl comprises, in its closed position, a bolt 49 cooperating with a striker 51 supported by the guide rail 53.

The bolt 49 is secured to a fixed structure 55 of the cascade-type thrust reverser.

The switching of the locking/unlocking device 17 from its closed position to an open position is achieved by the pivoting of the bolt 49 about a substantially radial pivot axis 56.

According to the present disclosure, an inhibiting pin 57 is positioned proximate to the bolt 49, in the surface that is swept by the pivoting of the bolt during the switching from its closed position to its open position, and such that the pivoting of the bolt 49 is blocked by the inhibiting pin 57 so as to hold the bolt 49 in its closed position.

According to a feature of the present disclosure, the inhibiting pins 41, 45 and 57 adopt a cylindrical shape, but it goes without saying that any other shape may be adopted, such as for example a conical or a parallelepiped shape, if this may be of particular interest for those skilled in the art.

According to another form, the locking/unlocking system may be a tertiary lock.

Thanks to the present disclosure, the setting up of the mechanical inhibition device is simplified in comparison with the known solutions of the prior art.

Indeed, by acting on the locking/unlocking device for holding the movable element of the thrust reverser in its retracted position, the time duration and the cost of the maintenance operation are significantly reduced in comparison with those of the prior art.

Furthermore, by providing a simple pin or screw for blocking the device, the cost of the mechanical inhibition device is also reduced.

Finally, the present disclosure is not limited to the sole forms of this mechanical inhibition device for a thrust reverser, described above only as illustrative examples but, on the contrary, encompasses all variants that involve the technical equivalents of the described means as well as their combinations if these fall within the scope of the present disclosure.

What is claimed is:

1. A thrust reverser device for a nacelle of a by-pass turbojet engine, comprising:
diverting means configured to divert at least one portion of an air flow of the turbojet engine, said diverting means comprising at least one movable element moving alternately between a deployed position in which said at least one movable element opens a passage within the nacelle and a retracted position in which said at least one movable element closes said passage;
a locking/unlocking system configured to lock and unlock said at least one movable element, the locking/unlocking system moving alternately between a closed position in which at least one bolt cooperates with at least one striker so as to hold said at least one movable element in the retracted position, and an open position in which said at least one bolt releases said at least one striker, so as to authorize a switching of said at least one movable element from the retracted position to the deployed position; and
a device for mechanically inhibiting said at least one movable element from a movement, holding in the retracted position,
wherein the mechanical inhibition device comprises means for holding the locking/unlocking system in the closed position.

2. The thrust reverser device according to claim 1, wherein the locking/unlocking system comprises:
said at least one bolt secured to a fixed structure of the thrust reverser device and pivotally mounted on a substantially radial pivot axis; and
said at least one striker secured to said at least one movable element and adapted so as to cooperate with said at least one bolt at least for one closed position of said locking/unlocking system so as to provide holding of said at least one movable element in the retracted position,
wherein the means for holding the locking/unlocking system in the closed position comprise at least one inhibiting pin or at least one inhibiting screw positioned so as to block the pivoting of said bolt from the closed position to the open position.

3. The thrust reverser device according to claim 2, wherein said at least one movable element is a door of a door-type thrust reverser device, wherein said fixed structure comprises at least one bore shaped so as to receive said at least one inhibiting pin or said at least one inhibiting screw.

4. The thrust reverser device according to claim 3, wherein said at least one bolt further comprises a bore positioned facing said at least one bore of the fixed structure of the thrust reverser device when the locking/unlocking system is in the closed position, and shaped so as to receive said at least one inhibiting pin or said at least one inhibiting screw.

5. The thrust reverser device according to claim 2, wherein said at least one movable element is a door of a door-type thrust reverser device, and wherein the fixed structure comprises a bore positioned proximate to said at least one bolt and shaped so as to receive said at least one inhibiting screw so as to block the pivoting of said at least one bolt from the closed position to the open position thereof.

6. The thrust reverser device according to claim 2, wherein said at least one movable element is a cowl of a cascade-type thrust reverser device, said cowl being movable in translation by means of at least one guide rail sliding along a direction substantially parallel to a longitudinal axis of said thrust reverser device along at least one slide secured to a fixed structure of the thrust reverser,
wherein said at least one guide rail comprises means for supporting said at least one inhibiting pin or said at least one inhibiting screw positioned proximate to said at least one bolt so as to block the pivoting of said at least one bolt from the closed position to the open position thereof when the movable cowl is in the retracted position.

7. The thrust reverser device according to claim 6, wherein the fixed structure of said thrust reverser device comprises a 12 o'clock beam and at least one front frame, wherein said cowl comprises an O-duct type cowl.

8. The thrust reverser device according to claim 1, wherein the locking/unlocking system is a tertiary lock.

9. A nacelle for a bypass turbojet engine comprising:
a front section for air inlet;
a mid-section surrounding a turbojet engine fan; and
a rear section equipped with a thrust reverser device according to claim 1.
